(19) United States
(12) Patent Application Publication
(10) Pub. No.: US 2009/0121369 A1
(43) Pub. Date: May 14, 2009

(54) APPARATUS FOR MOLDING OPTICAL ELEMENT AND METHOD FOR MOLDING OPTICAL ELEMENT

(75) Inventor: Shinji TANAKA, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: ASAHI GLASS COMPANY, LIMITED, Chiyoda-ku (JP)

(21) Appl. No.: 12/347,416

(22) Filed: Dec. 31, 2008

Related U.S. Application Data
(63) Continuation of application No. PCT/JP07/63573, filed on Jul. 6, 2007.

(30) Foreign Application Priority Data
Jul. 6, 2006 (JP) 2006-186831

(51) Int. Cl. B29D 11/00

(52) U.S. Cl. 264/1.32; 425/415

(57) ABSTRACT

A pressing device is provided so as to abut on an upper face of a drum mold of a mold to press the drum mold downward and fix the drum mold on a pedestal. While the drum mold is fixed to the pedestal by the pressing device, an upper mold is detached from and attached to the drum mold by a clamper. Further, a lower mold is engaged with a tapered engaging part of the drum mold through a tapered engaging part and fixed to the pedestal through the drum mold by the pressing device. According to this molding apparatus, the drum mold and the lower mold can be easily fixed to the pedestal by the pressing device irrespective of the presence or absence of an outer drum arranged in the outer periphery of the drum mold.

### CROSS-REFERENCE OF RELATED APPLICATION

This is a continuation application of PCT/JP2007/063573 which was filed on Jul. 6, 2007.

### BACKGROUND

The present invention relates to a molding apparatus and a molding method for manufacturing an optical element such as a highly accurate glass lens adapted to be used for an optical device.

Usually, a molding method has been widely put into practice that a glass material softened by heating is pressurized and molded to manufacture an optical element made of a glass lens. That is, for instance, the glass material preliminarily molded to a spherical form is arranged in a mold including an upper mold, a lower mold and a drum mold, heated at about 500 to 700° C. (different depending on the composition of glass) by a heating process to soften the glass material, then, pressurized to form into the optical element, and then, cooled to take out the optical element from the mold. These processes are carried out in a non-oxidizing atmosphere that oxygen does not enter to prevent the glass material in the mold from being oxidized. The glass material in the mold is sequentially conveyed to the processes of heating, pressurizing and molding and cooling respectively arranged on a single linear or annular conveying path to manufacture the optical element.

In the molding method of such an optical element, as a method for taking out a completely molded optical element from a mold and arranging a new glass material in the mold, a below-described method has been hitherto proposed.

FIGS. 8 and 9 are longitudinal section views of a conventional mold including an upper mold 2 having a flange part 1 formed in an upper part and a lower mold 3 having a flange part 1 formed in a lower part. A molding method of an optical element using this mold is disclosed in, for instance, Japanese Patent Publication Nos. 62-292636A and 6-271323A.

Further, in a procedure for taking out a molded optical element 4 from the mold and arranging a new glass material, a drum mold 6 is initially clamped from a side face by using a clamper 5 to fix the drum mold not so as to move. At this time, the flange part 1 of the lower mold 3 is also indirectly fixed by the clamper 5 through the drum mold 6. Then, the flange part 1 of the upper mold 2 is clamped from a side face by using another clamper 8 provided so as to be freely elevated or lowered to pull out the upper mold 2 from the drum mold 6. Then, a vacuum absorber (not shown) provided so as to be freely elevated or lowered is inserted into the drum mold 6 to vacuum-absorb and take out the molded optical element 4 from the drum mold 6. After that, the new glass material that is vacuum absorbed by another vacuum absorber (not shown) provided so as to be freely elevated or lowered is inserted into the drum mold 6 to release a vacuum adsorption and mount the glass material on an upper face (a molding face) of the lower mold 3.

Then, the upper mold 2 is inserted again into the drum mold 6 by the clamper 8. After that, the clamper 8 is released to mount the upper mold 2. Then, finally, the clamping of the drum mold 6 by the clamper 5 is released. The optical element 4 is replaced by the glass material in accordance with the above-described procedure. Reference numeral 9 designates a pedestal on which the mold is mounted.

In order to highly accurately mold the optical element 4, the upper mold 2 and the lower mold 3 need to be accurately assembled. Accordingly, the upper mold 2, the lower mold 3 and the drum mold 6 are precisely worked so that gaps of engagement are about several micrometers when the upper mold 2, the lower mold 3 and the drum mold 6 are assembled. However, when the gap of engagement is small as short as several micrometers, if even a slight deviation or inclination is generated between the axis of the upper mold 2 and the axis of the drum mold 6 during assembling them, a problem arises that the upper mold 2 is hardly inserted into and pulled out from the drum mold 6. To solve this problem, the clamper 8 of the upper mold 2 used when the optical element 4 is replaced by the glass material is ordinarily provided with a compliance mechanism for correcting the deviation between the axis of the upper mold 2 and the axis of the drum mold 6.

However, there is a limit in the tolerance of the deviation or the inclination of the axis by the compliance mechanism. When the deviation or the inclination is large so as to exceed the tolerance, the upper mold 2 may collide with the drum mold 6 or gall the drum mold 6. Therefore, the upper mold 2 cannot be satisfactorily inserted into or pulled out from the drum mold 6. In a terrible case, the edge part of the upper mold 2 or the drum mold 6 is cut out.

As another method is disclosed in, for instance, Japanese Patent Publication No. 2005-247640A. According to this method, tapered parts are formed in the upper outer peripheral part and the lower outer peripheral part of a drum mold. The outer end parts of an upper mold and a lower mold corresponding to the upper outer peripheral part and the lower outer peripheral part are extended to parts near the outer periphery of the drum mold and have tapered parts formed to tightly fit the tapered parts of the upper mold and the lower mold to the tapered parts of the drum mold. According to such a method, the deviation in position of the upper mold and the lower mold relative to the drum mold can be minimized and the upper mold and the lower mold can be easily fitted to the drum mold.

In the conventional method, when the mold is assembled and disassembled, the drum mold is ordinarily fixed directly by the clamper provided in the side face. However, in this case, since the lower mold is fixed by holding the side face of the drum mold to indirectly hold the flange part of the lower mold, a problem arises that a lower mold having no flange part cannot be fixed and when an upper mold is pulled out, the lower mold moves upward or downward.

Further, in the usual mold, a problem arises that when the entire part of the mold is lifted and carried, the lower mold slips out. Thus, when the entire part of the mold is lifted, the lower mold needs to be separately supported from a lower part.

Further, when an upper mold having no flange part is used, if the upper mold is clamped from a side face by using a clamper, there is a possibility that a precisely worked sliding part is directly clamped so that a finished face may be broken or deformed.

In the mold disclosed in the Japanese Patent Publication No. 2005-247640A, not only the problem that when the mold is lifted, the lower mold slips out cannot be solved, but also a thermal capacity is large due to a fact that the volume of the lower mold is unnecessarily large. Accordingly, the mold is not undesirably suitable for shortening a molding time.

### SUMMARY

Therefore, an advantageous aspect of the present invention is to provide a molding apparatus for an optical element and a molding method for an optical element in which the optical element can be easily replaced by a glass material in a simple manner.

According to the present invention, there is provided a molding apparatus for an optical element, in which while a mold having a tubular drum mold and an upper mold and a lower mold fitted to the drum mold is carried, processes of heating, pressurizing and molding and cooling are sequentially applied to the mold, said molding apparatus comprising:

a presser, that presses the drum mold downward to fix the drum mold to a pedestal,

wherein the drum mold is fixed to the pedestal by the presser to make the upper mold detached from and attached to the drum mold.

According to the present invention, there is also provided a molding method for an optical element in which while a mold having a tubular drum mold and an upper mold and a lower mold fitted to the drum mold is carried, processes of heating, pressurizing and cooling are sequentially applied to the mold, wherein the upper mold is detached from and attached to the drum mold while the drum mold is pressed downward by a presser to fix the drum mold to a pedestal.

With this configurations, since the drum mold is fixed to the pedestal by the presser, the drum mold can be easily fixed to the pedestal and the upper mold can be easily detached from the drum mold irrespective of the presence or absence of an outer drum arranged in the outer periphery of the drum mold. Further, when the outer drum is provided, the outer drum has hitherto needed to be previously removed to detach the upper mold from the drum mold, however, in the present invention, the upper mold can be detached without removing the outer drum by fixing the drum mold.

The lower mold may be engaged with the drum mold through an engaging part and fixed to the pedestal through the drum mold.

In this case, since the lower mold is engaged with the drum mold through the engaging part, the lower mold can be reliably fixed to the pedestal by merely pressing the drum mold by the presser and only the upper mold can be detached from the drum mold during detaching the upper mold.

The engaging part may be a protruding part or a tapered part formed in an outer periphery of the lower part of the lower mold.

In this case, the lower mold can be reliably fixed to the pedestal by merely pressing the drum mold. Further, the drum mold is pressed against the lower mold through the tapered part, so that the lower mold can be easily aligned. Further, when the tapered parts of the lower mold and the drum mold are engaged with each other, not only the axis of the lower mold can be easily aligned with the axis of the drum mold even in a relatively loose engagement, but also the lower mold and the upper mold can be reliably assembled. Thus, when the drum mold is lifted, the lower mold is not slipped off and a carrier for supporting the lower mold from a lower part does not need to be separately prepared. Further, the protruding part may be provided in pace of the tapered part.

There may be configured such that: a tubular guide member may be provided as the presser; an inner diameter of the guide member is larger than an inner diameter of the drum mold; a gap between the guide member and the upper mold is 50 times or smaller as narrow as a gap between the drum mold and the upper mold; and the guide member is mounted on an upper part of the drum mold so that the drum mold is fixed on the pedestal through the guide member.

In this case, since the guide member having the inner diameter slightly larger than the inner diameter of the drum mold is mounted on the upper part of the drum mold to press the drum mold against the pedestal through the guide member, even in a mold having a strict engagement, the upper mold can be prevented from being inclined and easily inserted into and pulled out relative to the drum mold without galling the drum mold.

There may be provided an axis aligner, that substantially aligns a central axis of an inner periphery of the guide member with a central axis of an inner periphery of the drum mold.

In this case, the axis of the guide member is substantially aligned with the axis of the drum mold by the axis aligner, so that the upper mold is prevented from being misaligned with the drum mold without providing a compliance mechanism and the upper mold can be easily inserted into or pulled out from the drum mold without galling the drum mold.

There may be provided an upper mold absorber and holder, that absorbs and holds the upper mold. The upper mold is absorbed and held by the upper mold absorber and holder to make the upper mold detached from and attached to the drum mold.

In this case, the upper mold is absorbed and held by the upper mold absorber and holder, so that even the upper mold having no flange part can be easily inserted into and pulled out from the drum mold without breaking or deforming a side face.

There may be provided a lower mold absorber and holder, that absorbs and holds the lower mold. The lower mold is absorbed and held by the lower mold absorber and holder to make the upper mold detached from and attached to the drum mold.

In this case, since the lower mold is absorbed and held by the lower mold absorber and holder to make the upper mold detached from and attached to the drum mold, the upper mold can be reliably inserted and pulled out along the guide member.

When the upper mold is to be detached from the drum mold without providing the lower mold absorber and holder, since a negative pressure is generated in the drum mold under a substantially sealed state having no space, the upper mold is hardly detached from the drum mold. Further, when the upper mold is forcibly detached from the drum mold, the lower mold is lifted together with the upper mold so that there may be occurred an inconvenience that the lower mold and the upper mold cannot be disassembled. As in the present invention, the lower mold absorber and holder is provided so that such an inconvenience can be avoided.

The lower mold may be provided with the engaging part engaged with the drum mold. The upper mold may be detached from and attached to the drum mold under a state that the lower mold is engaged with the drum mold by the engaging part.

In this state, under a state that the drum mold is pressed against the pedestal by the guide member, the upper mold is detached from the drum mold. At this time, since the engaging part of the lower mold is engaged with the drum mold pressed against the pedestal by the guide member, the lower mold is prevented from being slipped off from the drum mold. Thus, the same effects as described above can be obtained.

### BRIEF DESCRIPTION OF THE DRAWINGS

FIG. 1 is a reference view of a mold in which a lower mold is fixed by a vacuum adsorption.

FIG. 2 is a reference view of a mold in which a lower mold is fixed through an opening in the side face of a drum mold.

FIG. 3 is a section view showing a first embodiment of a mold in which a drum mold and a lower mold are fixed by pressing the upper end part of the drum mold.

FIG. 4 is a section view showing a second embodiment of a mold in which an upper mold is inserted and pulled out by using a guide member.

FIG. 5 is a section view showing a third embodiment of a mold in which a drum mold is pressed without detaching an outer drum.

FIG. 6 is a section view showing a fourth embodiment of a mold having a lower mold absorbing pad.

FIG. 7 is a section view showing a fifth embodiment of a mold in which a lower mold has an engaging part engaged with a drum mold.

FIG. 8 is a section view showing a conventional mold for an optical element.

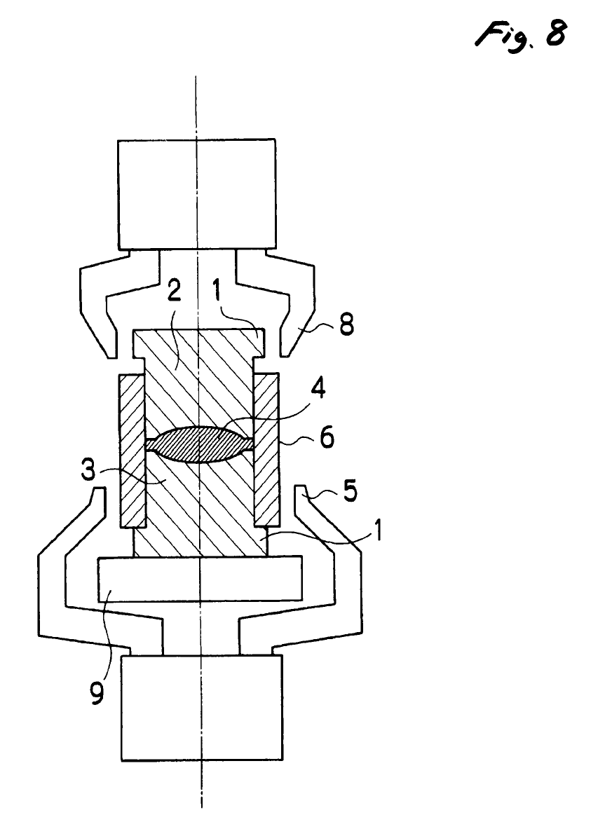

FIG. 9 is a section view showing a conventional mold for an optical element.

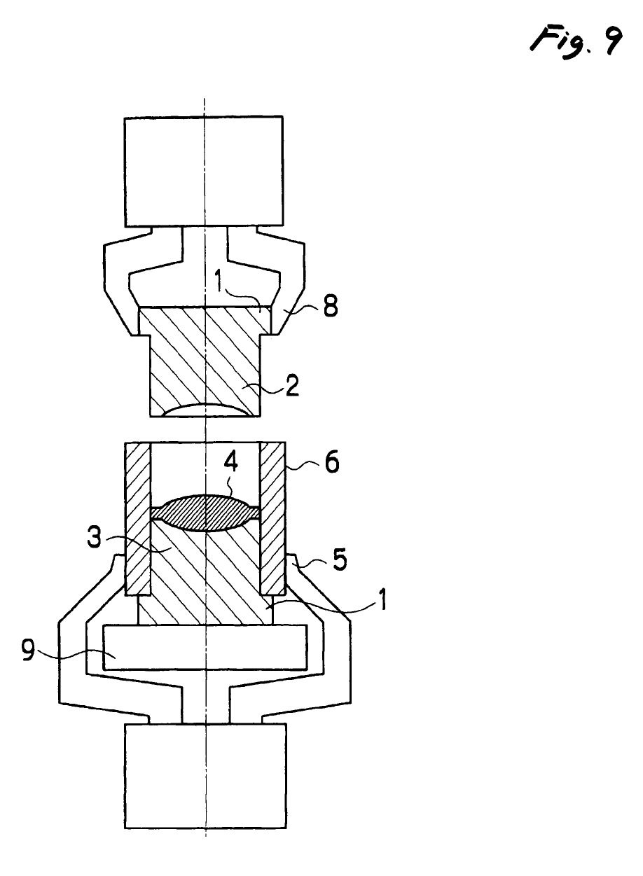

FIG. 10 is a section view showing a conventional double drum type mold.

### DETAILED DESCRIPTION OF EXEMPLIFIED EMBODIMENTS

With reference to the accompanying drawings, preferred embodiments of a molding apparatus for an optical element and a molding method for an optical element according to the present invention will be described below.

A mold, a molding apparatus and a molding method for an optical element shown in the following drawings designate a mold, a molding apparatus and a molding method for molding an optical element by carrying a mold including a tubular drum mold and an upper mold and a lower mold fitted to the drum mold and sequentially applying processes of heating, pressurizing and molding and cooling respectively to the mold to easily and inexpensively realize a purpose of highly accurately assembling the mold and easily replacing a molded optical element by a glass material.

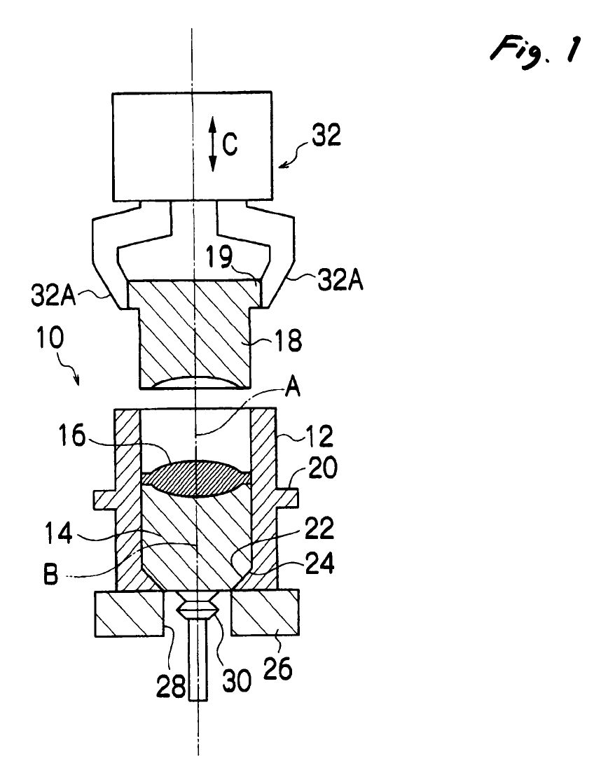

FIG. 1 is a section view of a mold 10 used as a reference for explaining a molding apparatus for an optical element and a molding method for an optical element of the present invention.

The mold 10 shown in FIG. 1 includes a tubular drum mold 12, a lower mold 14 fitted to the drum mold 12, an upper mold 18 fitted to the drum mold 12 with a gap of several micrometers and arranged so as to be freely taken in and out (slide) relative to the drum mold 12 when an optical element 16 is replaced by a glass material not shown in the drawing. The upper face of the lower mold 14 and the lower face of the upper mold 18 are optical element molding faces and the glass material is arranged between them. The glass material is heated in a heating process and pressurized and molded in a pressurizing and molding process to be molded to an optical element. Further, on an outer peripheral face of the drum mold 12, a flange 20 is formed and the mold 10 is carried or lifted by using the flange 20. The drum mold 12, the lower mold 14 and the upper mold 18 are made of, for instance, tungsten carbide. Particularly, a sliding part of the upper mold 18 except a flange part 19 that is fitted to and pulled out from the drum mold 12 is highly accurately and precisely finished and worked to improve the quality of the optical element.

In the inner peripheral edge part of the lower part of the drum mold 12, a tapered engaging part 22 is formed. Also in the lower mold 14, a tapered engaging part 24 is formed. These tapered engaging parts 22 and 24 are engaged with each other under a state that the mold 10 is vertically mounted on a pedestal 26. Further, under the engaged state, an axis A of the drum mold 12 is substantially aligned with an axis B of the lower mold 14 in accordance with the axis aligning operation of the tapered parts. Further, when the drum mold 12 is lifted by using the flange 20, the lower mold 14 is prevented from dropping from the drum mold 12.

In the pedestal 26 on which the mold 10 is mounted, a through hole 28 is formed. An absorbing pad 30 is inserted through the through hole 28 from a lower part of the pedestal 26 and allowed to abut on the lower face of the lower mold 14. Thus, the lower mold 14 is vacuum absorbed and held by the absorbing pad 30 and temporarily fixed to the pedestal 26 and the drum mold 12 is also temporarily fixed to the pedestal 26 by the engaging operation of the tapered engaging parts 22 and 24 through the lower mold 14.

By using the mold 10 constructed as described above, a procedure for taking out the molded optical element 16 from the mold 10 and arranging a new glass material will be described below.

Initially, the lower mold 14 is absorbed and held by the absorbing pad 30 to temporarily fix the lower mold 14 and the drum mold 12 to the pedestal 26. Then, the flange part 19 of the upper mold 18 is clamped from a side face by using a clamper 32 provided so as to be freely lifted and lowered in directions shown by arrows C to pull out the upper mold 18 from the drum mold 12. At this time, since the lower mold 14 is fixed to the pedestal 26 by the absorbing pad 30, the lower mold 14 is not pulled out from the drum mold 12 together with the upper mold 18 when the upper mold 18 is pulled out from the drum mold 12. Then, a vacuum absorber (not shown) that is provided to be freely lifted and lowered is inserted into the drum mold 12 to vacuum-absorb the molded optical element 16 and take out the optical element from the drum mold 12. After that, the new glass material vacuum absorbed by another vacuum absorber (not shown) that is provided to be freely lifted and lowered is inserted into the drum mold 12 to release a vacuum adsorption and mount the glass material on the molding face of the lower mold 14. Subsequently, the upper mold 18 is inserted again into the drum mold 12 by the clamper 32. Then, the clamper 32 is released to mount the upper mold 18. In accordance with the above-described procedure, the optical element 16 is completely replaced by the glass material.

As described above, in the mold 10 shown in FIG. 1, the lower mold 14 is fixed to the pedestal by vacuum-absorbing the lower mold 14 by the absorbing pad 30, so that even the lower mold 14 having no flange part can be easily fixed to the pedestal 26 without using the drum mold 12. Further, since the tapered engaging parts 22 and 24 are provided in the drum mold 12 and the lower mold 14, the drum mold 12 can be easily fixed to the pedestal 26 through the lower mold 14. Further, even in a relatively loose engagement, not only the axis of the lower mold 14 can be easily substantially aligned with the axis of the drum mold 12, but also the lower mold 14 and the upper mold 18 can be accurately mounted by the tapered engaging parts 22 and 24. Even when the drum mold 12 is lifted, the lower mold 14 is not slipped off from the drum mold 12 and a carrier for supporting the lower mold 14 from a lower part does not need to be separately prepared.

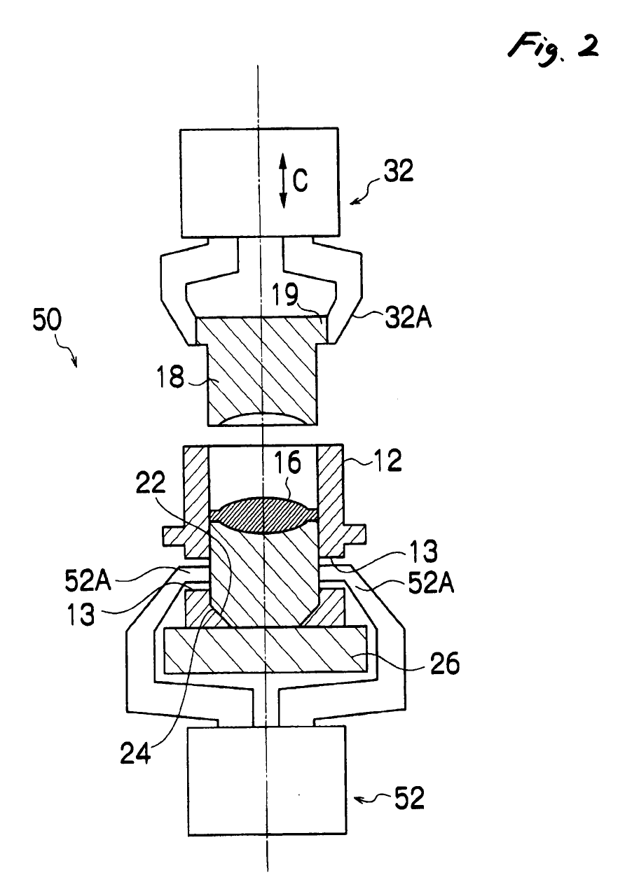

FIG. 2 is, similarly to FIG. 1, a section view of a mold 50 used as a reference for explaining a molding apparatus for an optical element and a molding method for an optical element of the present invention. The same or similar members to those of the mold 10 shown in FIG. 1 are designated by the same reference numerals and an explanation thereof will be omitted.

The mold 50 is provided with a clamper 52 for clamping a lower mold 14 through openings 13 formed in the side face of a drum mold 12. Chucking claws 52A of the clamper 52 are inserted into the openings 13 so that the lower mold 14 is clamped by the chucking claws 52A. Under this state, an upper mold 18 is detached from and attached to the drum mold 12 by a clamper 32.

In the mold 50 shown in FIG. 2, the lower mold 14 is clamped from the openings 13 of the drum mold 12 by the clamper 52. Thus, even the lower mold 14 having no flange part can be easily fixed to a pedestal 26. Further, a vertical movement of the drum mold 12 can be limited by the chucking claws 52A. The openings 13 may be formed exclusively for chucking, however, openings, that are formed in advance for substituting inert gas such as nitrogen for oxygen in the drum mold 12, or openings for preventing a negative pressure in the drum mold 12 may be used.

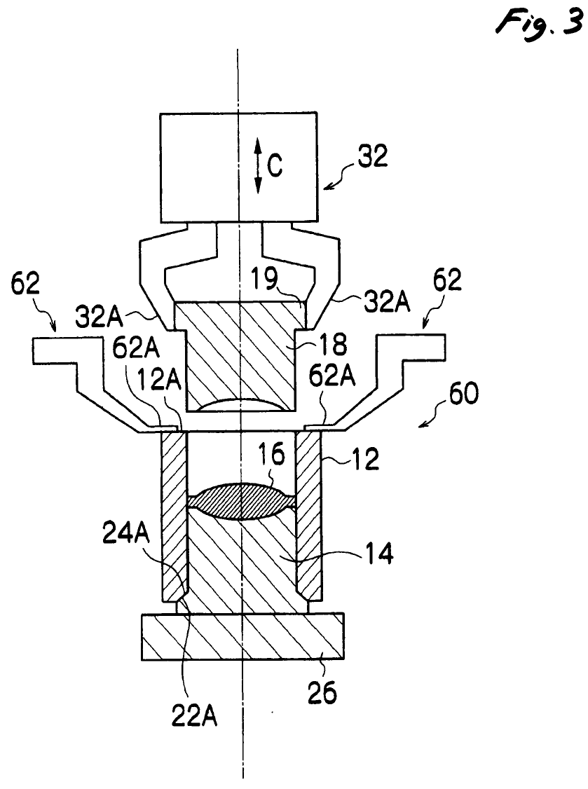

FIG. 3 is a section view showing a first embodiment of the present invention. Members the same as or similar to those of the mold 10 shown in FIG. 1 are designated by the same reference numerals and an explanation thereof will be omitted.

In the first embodiment shown in FIG. 3, a pressing device (a presser) 62 is provided that abuts on the upper face 12A of a drum mold 12 of a mold 60 and presses the drum mold 12 downward to fix the drum mold to a pedestal 26. While the drum mold 12 is fixed to the pedestal 26 by pressing claws 62A of the pressing devices 62, an upper mold 18 is detached from and attached to the drum mold 12 by a clamper 32.

Further, a lower mold 14 is engaged with a tapered engaging part 22A of the drum mold 12 through a tapered engaging part 24A and fixed to the pedestal 26 by the pressing device 62 through the drum mold 12. In this embodiment, as an engaging part, the tapered engaging parts 22A and 24A are exemplified, however, the engaging part is not limited thereto. An engaging part having a form (for instance, a protruding form) and a function that can fix the lower mold 14 to the pedestal 26 through the drum mold 12 may be employed.

According to the embodiment shown in FIG. 3, since the drum mold 12 is pressed to the pedestal 26 by the pressing device 62, the drum mold 12 and the lower mold 14 can be easily fixed to the pedestal 26 irrespective of the presence or absence of an outer drum provided in the outer periphery of the drum mold 12.

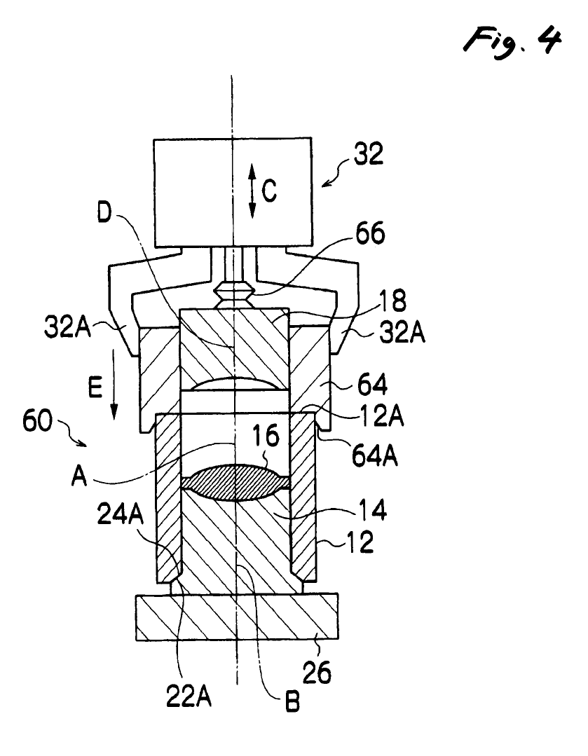

FIG. 4 is a section view showing a second embodiment of the present invention. Members the same as or similar to those of the mold 10 shown in FIG. 1 are designated by the same reference numerals and an explanation thereof will be omitted.

In the second embodiment shown in FIG. 4, a tubular guide member 64 having an inner diameter slightly larger than that of a drum mold 12 is mounted on the upper face 12A of the drum mold 12. Then, an absorbing pad (an upper mold absorber and holder) 66 is provided that vacuum-absorbs and holds an upper mold 18 and moves the upper mold upward and downward so as to move along the inner periphery of the guide member 64. The absorbing pad 66 is moved upward and downward to detach the upper mold 18 from and attach the upper mold 18 to the barred mold 12. The upper mold 18 is absorbed and held by the absorbing pad 66, so that the upper mold 18 having no flange part can be easily inserted into and pulled out from the drum mold 12 without breaking or deforming a side face.

The inner diameter of the guide member 64 is larger than the inner diameter of the drum mold 12. Further, a gap between the guide member 64 and the upper mold 18, that is, a difference between the inner diameter of the guide member 64 and the outside diameter of the upper mold 18 (refer it to as Δ1, hereinafter) is 50 times or smaller as narrow as a gap between the drum mold 12 and the upper mold 18, that is a difference between the inner diameter of the drum mold 12 and the outside diameter of the upper mold 18 (refer it to as Δ2, hereinafter). When Δ1 exceeds 50 times as narrow as Δ2, there is a possibility that when the upper mold 18 is inserted into and detached from the drum mold 12, the upper mold 18 is inclined to gall the drum mold 12. Δ1 is preferably 30 times or smaller as narrow as Δ2. Δ1 is more preferably 20 times or smaller as narrow as Δ2. Δ1 is more preferably 10 times or smaller as narrow as Δ2.

On the other hand, when Δ1 is substantially equal to Δ2, since an effect of use of the guide member 64 is low, Δ1 is preferably 1.5 times or larger as narrow as Δ2, and Δ1 is more preferably 2.0 times or larger as narrow as Δ2. For instance, designs may be exemplified as preferred examples that the gap Δ2 between the drum mold 12 and thee upper mold 18 is set to about 5 micrometers, and the gap Δ1 between the guide member 64 and the upper mold 18 is set to 10 to 50 micrometers, and more preferably set to 15 to 25 micrometers.

Further, in the inner peripheral face of the lower part of the guide member 64, a tapered face (an axis aligner) 64A having an end widened is formed. The guide member 64 is mounted on the upper face 12A of the drum mold 12 by a clamper 32 for clamping the guide member 64 so that a central axis D of the inner diameter of the guide member 64 is automatically substantially aligned with a central axis A of the inner diameter of the drum mold 12 due to the weight of the guide member 64.

Further, the clamper 32 also has a function of a presser for pressing the drum mold 12 to a pedestal 26 in a direction shown by an arrow mark E through the guide member 64.

According to the embodiment shown in FIG. 4, by using the guide member 64 having the inner diameter slightly larger than that of the drum mold 12, even in a mold strict in its engagement, the inclination of the upper mold 18 is prevented and the upper mold 18 can be easily inserted into and pulled out from the drum mold 12 without galling the drum mold.

Further, the axis D of the guide member 64 is substantially aligned with the axis A of the drum mold 12 by using the tapered face 64A of the guide member 64. Thus, while the axis of the upper mold 18 is prevented from being misaligned with the axis of the drum mold 12, the upper mold 18 can be easily inserted into and pulled out from the drum mold 12 without galling the drum mold 12.

Further, the drum mold 12 is pressed to the pedestal 26 by the clamper 32 through the guide member 64, so that the drum mold 12 can be easily fixed to the pedestal 26 without separately preparing another device.

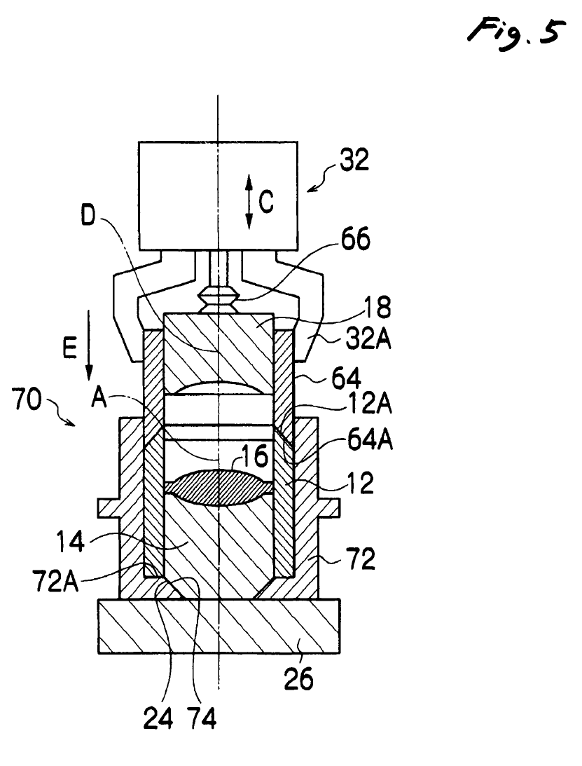

FIG. 5 is a section view showing a third embodiment of the present invention. Members the same as or similar to those of the second embodiment shown in FIG. 4 are designated by the same reference numerals and an explanation thereof will be omitted.

A mold 70 shown in FIG. 5 is a double drum type mold formed by inserting a drum mold 12 into an outer drum 72 made of stainless steel. The drum mold 12 is mounted on a flat part 72A of an upper face of a flange formed in the inner periphery of the outer drum 72 so that the drum mold 12 is prevented from being slipped off from the outer drum 72. Further, a lower mold 14 has a tapered engaging part 24 formed in the lower part thereof that is engaged with a tapered engaging part 74 of the outer drum 72, so that the lower mold 14 is prevented from being slipped off from the outer drum 72.

Further, in an outer peripheral face of a lower part of a guide member 64, a tapered face 64A is formed. This tapered face 64A is engaged with a tapered face 12A formed on the upper face of the drum mold 12 so that a central axis D of the inner diameter of the guide member 64 is substantially aligned with a central axis A of the inner diameter of the drum mold 12.

Further, an absorbing pad 66 is provided for vacuum-absorbing and holding and moving an upper mold 18 upward and downward so as to move along the inner periphery of the guide member 64. The absorbing pad 66 is moved upward and downward to detach the upper mold 18 from and attach the upper mold 18 to the drum mold 12. Further, a clamper 32 also has a function of a presser for pressing the drum mold 12 to a pedestal 26 in a direction shown by an arrow mark E through the guide member 64. As described above, the drum mold 12 is pressed to the pedestal 26, so that the outer drum 72 having the flat part 72A of the upper face on which the drum mold 12 is mounted can be pressed and fixed to the pedestal 26.

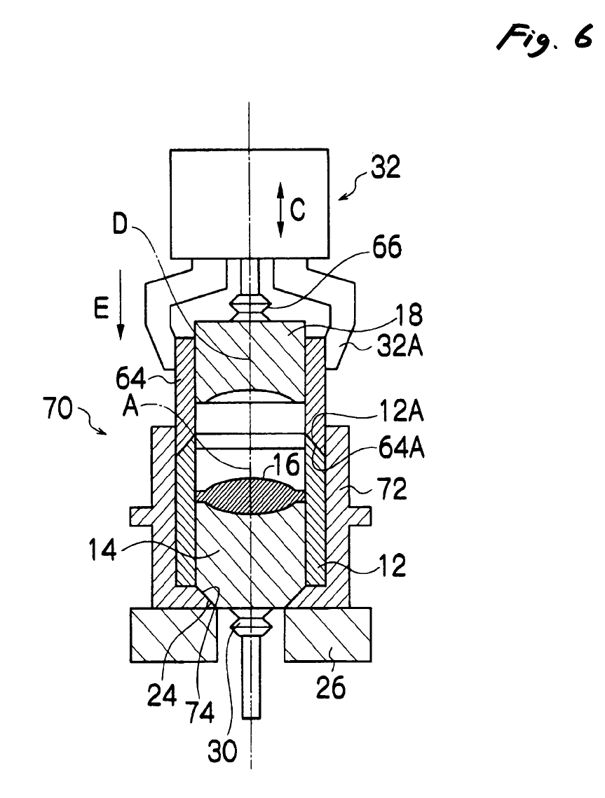

FIG. 6 is a section view showing a fourth embodiment of the present invention. Members the same as or similar to those of the third embodiment shown in FIG. 5 are designated by the same reference numerals and an explanation thereof will be omitted.

A molding apparatus for an optical element shown in FIG. 6 is provided with an absorbing pad (a lower mold absorber and holder) 30 for absorbing and holding a lower mold 14.

In the molding apparatus for the optical element, the lower mold 14 is absorbed and held by the absorbing pad 30 to detach an upper mold 18 from and attach the upper mold 18 to a drum mold 12. Thus, the upper mold 18 can be reliably inserted into and pulled out along a guide member 64.

When the upper mold 18 is to be detached from the drum mold 12 without providing the absorbing pad 30, since a negative pressure is generated in the drum mold 12 in a substantially sealed state, the upper mold 18 is hardly detached from the drum mold 12. Further, when the upper mold 18 is to be forcibly detached from the drum mold 12, the lower mold 14 is lifted together with the upper mold 18 so that there may be occurred an inconvenience that the upper mold 18 and the lower mold 14 cannot be disassembled.

Thus, as in the molding apparatus for the optical element shown in FIG. 6, the absorbing pad 30 for absorbing the lower mold 14 is provided so that the above-described inconvenience can be eliminated.

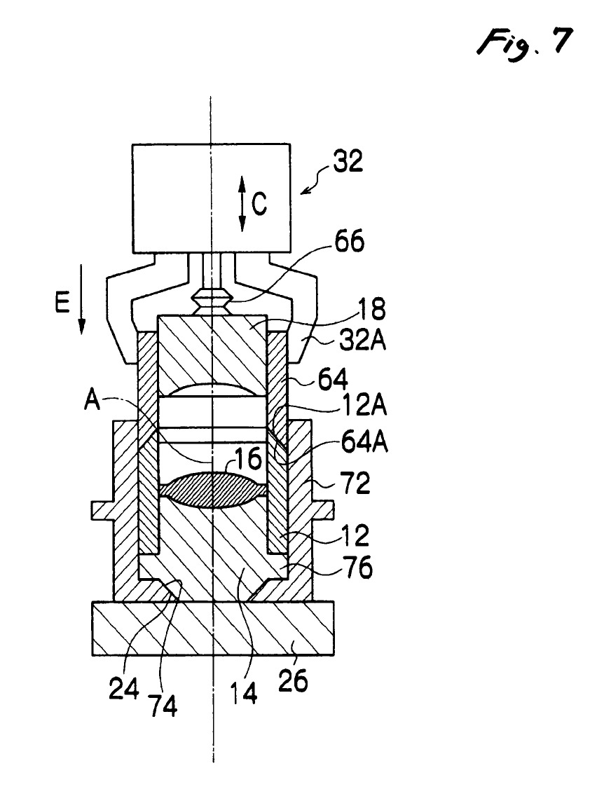

FIG. 7 is a section view showing a fifth embodiment of the present invention. Members the same as or similar to those of the fourth embodiment shown in FIG. 6 are designated by the same reference numerals and an explanation thereof will be omitted.

In a molding apparatus for an optical element shown in FIG. 7, a flange (an engaging part) 76 engaged with the lower end part of a drum mold 12 is formed in the lower part of a lower mold 14.

In the molding apparatus for the optical element, while the drum mold 12 is pressed against a pedestal 26 through a guide member 64, an upper mold 18 is detached from the drum mold 12 by an absorbing pad 66. At this time, since the lower mold 14 has the flange 76 engaged with the lower end part of the drum mold 12 pressed by the guide member 64, the lower mold 14 is prevented from being slipped off from the drum mold 12. Thus, as in the molding apparatus for the optical element shown in FIG. 6, when the upper mold is detached from the drum mold 12, the lower mold 14 can be reliably fixed. The engaging part for preventing the lower mold 14 from being slipped off from the drum mold 12 is not limited to the flange 76, and any form may be used. Further, the engaging part may not be formed in the lower mold 14 and may be formed in the drum mold 12.

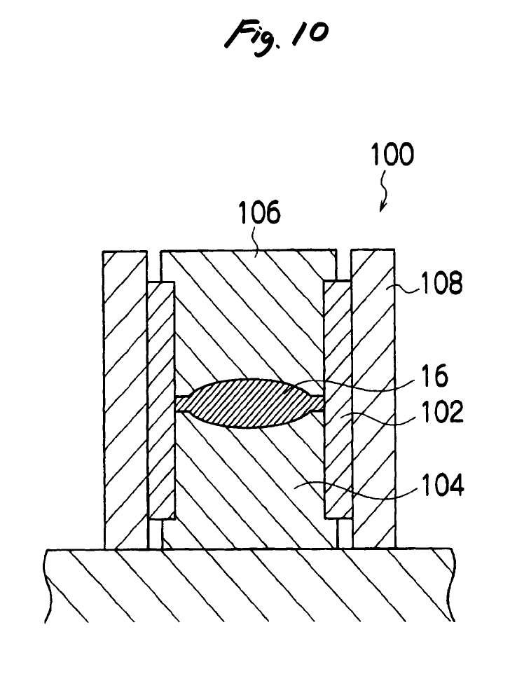

In a conventional double drum type mold 100 shown in FIG. 10, an upper mold 106 cannot be taken out (pulled out) from a drum mold 102 if the drum mold 102 and a lower mold 104 are not clamped by any clamper. Since an outer drum 108 is provided outside the drum mold 102, the outer drum 108 interferes with the drum mold 102 so that the drum mold 102 cannot be clamped. Under this state, when the upper mold 106 is to be forcibly pulled out, the drum mold 102 and the lower mold 104 are pulled out together with the upper mold 106 from the outer drum 102 due to a vacuum pressure generated from a strict engagement. Thus, the mold 100 cannot be disassembled so that an optical element 16 is hardly replaced by a glass material.

Therefore, conventionally, the outer drum 108 is first temporarily detached from the drum mold 102. In this case, since the drum mold 102 is loosely engaged with the outer drum 108, the outer drum 108 can be simply detached from the drum mold 102. Then, the drum mold 102 and the lower mold 104 are clamped by a clamper. Under this state, the upper mold 106 is detached from the drum mold 102 to replace the optical element 16 by the glass material. Subsequently, the upper mold 106 is inserted into the drum mold 102, and then, the drum mold 102 is covered with the outer drum 108. In accordance with the above-described operations, the optical element 16 is completely replaced by the glass material. As described above, since, conventionally, it takes much time to disassemble the mold 100, a long time cycle is disadvantageously necessary for molding the optical element 16.

As compared therewith, in the double drum type mold 70 shown in FIGS. 5 to 7, since the drum mold 12 is pressed against the pedestal 26 by the guide member 64, the upper mold 18 can be pulled out from the drum mold 12 without detaching the outer drum 72 from the drum mold 12. Thus, since a tact time necessary for replacing an optical element 16 by a glass material can be shortened, a cycle time necessary for molding the optical element can be greatly shortened.

In the first embodiment shown in FIG. 3, as the clamper 32 of the upper mold 18, a device having a plurality of chucking claws 32A is exemplified. However, the clamper is not limited thereto, and as shown in FIGS. 4 and 5, the upper mold may be clamped by the absorbing pad 66 to be lifted or lowered.

The present invention may be applied to other molding method for an optical element in which while a mold including an upper mold, a lower mold and a drum mold is moved, processes of heating, pressurizing and molding and cooling are sequentially respectively applied to the mold.

What is claimed is:

1. A molding apparatus for an optical element, in which while a mold having a tubular drum mold and an upper mold and a lower mold fitted to the drum mold is carried, processes of heating, pressurizing and molding and cooling are sequentially applied to the mold, the molding apparatus comprising:
a presser, that presses the drum mold downward to fix the drum mold to a pedestal,
wherein the drum mold is fixed to the pedestal by the presser to make the upper mold detached from and attached to the drum mold.

2. The molding apparatus for the optical element as set forth in claim 1, wherein the lower mold is engaged with the drum mold through an engaging part and fixed to the pedestal through the drum mold.

3. The molding apparatus for the optical element as set forth in claim 2, wherein the engaging part is a protruding part or a tapered part formed in an outer periphery of the lower part of the lower mold.

4. The molding apparatus for the optical element as set forth in claim 1, wherein:
a tubular guide member is provided as the presser;
an inner diameter of the guide member is larger than an inner diameter of the drum mold;
a gap between the guide member and the upper mold is 50 times or smaller as narrow as a gap between the drum mold and the upper mold; and
the guide member is mounted on an upper part of the drum mold so that the drum mold is fixed on the pedestal through the guide member.

5. The molding apparatus for the optical element as set forth in claim 4, further comprising:
an axis aligner, that substantially aligns a central axis of an inner periphery of the guide member with a central axis of an inner periphery of the drum mold.

6. The molding apparatus for the optical element as set forth in claim 1, further comprising:
an upper mold absorber and holder, that absorbs and holds the upper mold,
wherein the upper mold is absorbed and held by the upper mold absorber and holder to make the upper mold detached from and attached to the drum mold.

7. The molding apparatus for the optical element as set forth in claim 1, further comprising:
a lower mold absorber and holder, that absorbs and holds the lower mold,
wherein the lower mold is absorbed and held by the lower mold absorber and holder to make the upper mold detached from and attached to the drum mold.

8. The molding apparatus for the optical element as set forth in claim 1, wherein:
the lower mold is provided with the engaging part engaged with the drum mold; and
the upper mold is detached from and attached to the drum mold under a state that the lower mold is engaged with the drum mold by the engaging part.

9. A molding method for an optical element in which while a mold having a tubular drum mold and an upper mold and a lower mold fitted to the drum mold is carried, processes of heating, pressurizing and cooling are sequentially applied to the mold, wherein the upper mold is detached from and attached to the drum mold while the drum mold is pressed downward by a presser to fix the drum mold to a pedestal.

10. The molding method for the optical element as set forth in claim 9, wherein the lower mold is engaged with the drum mold through an engaging part and fixed to the pedestal through the drum mold.

11. The molding method for the optical element as set forth in claim 10, wherein the engaging part is a protruding part or a tapered part formed in an outer periphery of the lower part of the lower mold.

12. The molding method for the optical element as set forth in claim 9, wherein:
a tubular guide member is provided as the presser;
an inner diameter of the guide member is larger than an inner diameter of the drum mold;
a gap between the guide member and the upper mold is 50 times or smaller as narrow as a gap between the drum mold and the upper mold; and
the guide member is mounted on an upper part of the drum mold so that the drum mold is fixed on the pedestal through the guide member.

13. The molding method for the optical element as set forth in claim 12, wherein a central axis of an inner periphery of the guide member is substantially aligned with a central axis of an inner periphery of the drum mold by an axis aligner.

14. The molding method for the optical element as set forth in claim 9, wherein the upper mold is detached from and attached to the drum mold while the upper mold is absorbed and held by an upper mold absorber and holder.

15. The molding method for the optical element as set forth in claim 9, wherein the lower mold is detached from and attached to the drum mold while the lower mold is absorbed and held by a lower mold absorber and holder.

16. The molding method for the optical element as set forth in claim 9, wherein the upper mold is detached from and attached to the drum mold under a state that the lower mold is engaged with the drum mold by an engaging part provided in the lower mold.
